(19) United States
(12) Patent Application Publication
(10) Pub. No.: US 2017/0233264 A1
(43) Pub. Date: Aug. 17, 2017

(54) DESALINATION SYSTEM FOR THE PRODUCTION OF POTABLE WATER

(71) Applicant: David Bradley Boylan, Encinitas, CA (US)

(72) Inventor: David Bradley Boylan, Encinitas, CA (US)

(21) Appl. No.: 15/432,902

(22) Filed: Feb. 14, 2017

Related U.S. Application Data
(60) Provisional application No. 62/295,651, filed on Feb. 16, 2016.

(51) Int. Cl. C02F 1/16; B01D 1/20; C02F 1/18; C02F 1/04; C02F 1/12; C02F 1/14; B01D 1/00; B01D 5/00

(52) U.S. Cl. CPC C02F 1/16; B01D 1/0058; B01D 1/20; B01D 5/006; B01D 5/0027; B01D 5/0087; B01D 1/0035; C02F 1/048; C02F 1/12; C02F 1/14; C02F 1/18; C02F 2103/08

(57) ABSTRACT

An evaporation and condensing system having a structure including an evaporator section and a condenser section. A first nozzle system is disposed in the evaporator section. The first nozzle system is in communication with a first feed pipe disposed at least partially in the structure, the first feed pipe is adapted to be in communication with a first substance. A second nozzle system is disposed in the condenser section. The second nozzle system is in communication with a second feed pipe disposed at least partially in the structure. The second feed pipe is adapted to be in communication with a second substance. A first porous knockout panel is disposed proximate the evaporator section. A second porous knockout panel is disposed proximate the condenser section. A first substance drain is disposed in the evaporator section. A second substance drain is disposed in the condenser section.

### CROSS-REFERENCE To RELATED APPLICATIONS

This application claims the benefit of U.S. Provisional Application Ser. No. 62/295,651 filed Feb. 16, 2016, which is hereby incorporated by reference in its entirety.

### TECHNICAL FIELD

The embodiments described herein are generally directed an evaporation and condensing system and method for the production of potable water.

### BACKGROUND

Conventional commercial desalination systems utilize either Reverse Osmosis; High Temperature distillation systems at temperatures above 212° Fahrenheit (F) and typically in the 250° F. range at sea level; or Vacuum Distillation systems. Desalination refers to the removal of salts, minerals, and other impurities from a target substance such as water.

Commercial Reverse Osmosis (RO) operations are performed as a room temperature process that forces source water through tubular membranes at high pressure. The emerging water is separated into two streams. One stream contains most of the salts; the other is a low salt containing stream. This RO operation requires the use of high pressure, high-tech pumps to operate the system. There is also a propensity of the membranes to clog requiring extensive water pretreatment. In addition, only a small portion of the water pumped through this RO system actually ends up as potable water. The Reverse Osmosis system requires constant monitoring and utilizes large amounts of electricity. It is easily contaminated by bio-films and other organisms from natural water streams and must be cleaned regularly. This solution requires constant and costly maintenance.

High Temperature desalination systems require temperatures above 212° F. at sea level. Generally the heat input is from high quality steam at temperatures at approximately 250° F. or higher. Heat resources in this range are considered primary heat sources and generally rely on burning fossil fuels to obtain these temperatures. High Temperature desalination systems produce carbon dioxide associated with global warning and remove a resource fuel that is better used elsewhere. Working with steam at these temperatures and pressures can be dangerous and requires constant monitoring. Because of the high temperatures and pressures involved, materials that can be used for construction are limited and expensive.

Vacuum Distillation systems are generally limited to small product volumes, are expensive to construct, require complicated vacuum pumps and must be monitored closely. They are also high maintenance systems.

The amount of heat required to vaporize a gallon of water at sea level is approximately 8,000 BTUs/gallon. Conventional desalination systems generally obtain this heat from steam produced by the burning of fossil fuels. As the temperature is lowered (120° F. to 160° F. range), the number of options for the input of heat for vaporization increase significantly. Heat in this range is considered low quality heat and is discarded as an unusable source.

Over thirty percent (30%) of the heat produced in the United States is lost due to the low quality of the heat (120° F. to 160° F. range) and the lack of development of systems that can take advantage of this resource. Besides industrial waste heat sources, power plant waste heat, environmental heat sources such as solar thermal and geothermal derived heat and heat recovery from combustion engines fall in this category.

### SUMMARY

The present description addresses the shortcomings of conventional commercial desalination systems. It is desirable to provide an efficient system that can produce quality potable water from contaminated, waste, or salt water sources at atmospheric pressure and temperatures in the 120° F. to 160° F. range without using the conventional systems discussed above. In addition, the system described here is inexpensive to build and operate, safe and requires only minimal maintenance and oversight. This system is also capable of automatic operation and remote monitoring. The system is able to utilize conventional heat sources as well as industrial waste heat or heat derived from environmental resources. The design provided is easily scaled from a system that meets potable water needs of a single family to a system that provides potable water for a community or larger scale. The system is portable and flexible allowing installation on land as well as water areas (ponds, estuaries, etc.).

One application of the present description is the production of quality potable water from salt water, waste water or other non-potable water sources at temperatures in the 120° F. to 160° F. range. The described system can use solar thermal heat, geothermal heat, wind, hydro, generator powered, or waste heat as possible sources for heat. The system allows the use of inexpensive, inflatable plastic structures and plastic piping and tanks as main construction materials in the systems operating below 160° F. thus lowering the cost of the system. The system is portable, easily scalable and can be adapted to either land or water. In addition, the production of distilled water below the boiling point of the feed material is very unique.

Since low temperatures are used, the structure housing the evaporator and condenser systems may be made as an inflatable plastic structure or a structure such as a shipping container lined with plastic bladders. Plastic liners or bladder interiors in the shipping containers produce a clean interior environment where evaporation and condensation can occur. These plastics are inexpensive, corrosive resistant and well adapted to the low temperature and atmospheric pressure experienced during operation.

The exemplary system described and illustrated below, is a salt water distillation type in the sense that the water is vaporized and then condensed. It is different from conventional distillation in that this happens at atmospheric pressure and at temperatures below the boiling point of water. This is accomplished by using a recycled carrier gas (usually but not limited to air) in the system. The evaporator section occupies half of the structure. The condenser section occupies the other half of the structure. The structure is divided by a partial wall with clearances at each end. This layout allows the carrier air to circulate through both the evaporator and the condenser sections in a clockwise manner. The salt water part of the system includes a salt water tank and a pump that pumps the salt water though a heat exchanger. The heat for this exchanger is provided by an auxiliary heat system such as a solar thermal heat generator or waste heat recovery unit. The resulting heated salt water is then spayed through nozzles into the evaporator part of the system.

The tanks for recycle and product collection can be polyethylene and thus are inexpensive and corrosion resistant. In larger systems, the tanks may be ponds that are insulated and covered.

The sprayers are mounted in such a way that salt spray heats the surrounding air and cause that air to circulate in a clockwise manner. Some of spray evaporates, saturating the air with vapor. The un-evaporated salt solution collects in the spent evaporator pan and flows by gravity into the salt water feed tank for recycle. The saturated hot air in the evaporator moves into the condenser section. Distilled Water (DW) from the product tank is pumped through a heat exchanger coil mounted in a cool water body such as a pond, the ocean or in water tank cooled by an evaporator chiller. The emerging cool DW is injected through nozzles mounted in the condenser in such a way that the clockwise movement of carrier air is enhanced. This spray comes in direct contact with the hot moist carrier gas cooling it and causing moisture to condense from it. The spent DW and the condensate removed from carrier air stream collect in the condenser pan and flow back into the DW tank where it is recycled. Product is removed from the DW tank once a certain level in this tank is achieved.

The exemplary system described above is a land-based system. It can be designed as a floating water-based system. The main condenser and evaporator sections are floatable, the tanks could be bladder tanks anchored below the inflatable structure and the pumps could be submersible mounted in the bladder tanks. Accommodations for the heat source would depend on the source and the cool heat sink would be the water body.

This system approach can also be used to clean up waste streams producing reusable water product; can be used to purify certain industrial chemicals; or by changing the carrier gas to an inert gas can be used to purify certain oxygen sensitive materials or combustible materials.

The systems operation is safe and easily automated requiring minimal human oversight.

### BRIEF DESCRIPTION OF THE DRAWINGS

FIG. 1 is a top view of an exemplary desalination facility embodied in the present description.

FIG. 2 is an explanatory view of the structure housing the evaporator and condenser sections.

FIG. 3 is an explanatory view of the cross section of the structure containing the evaporator section and the condenser section.

FIG. 4 is an explanatory view of one of the possible ways that an inflatable structure may be mounted on a foundation while maintaining a closed, water proof internal structure space.

### DETAILED DESCRIPTION

The embodiments described herein are not intended to be exhaustive or otherwise limit or restrict the claims to the precise form and configuration disclosed in the following detailed description. The system variation selected for this description is a low temperature, inflatable, desalination system. It should be noted that the following description and accompanying drawings do not restrict the claimed invention.

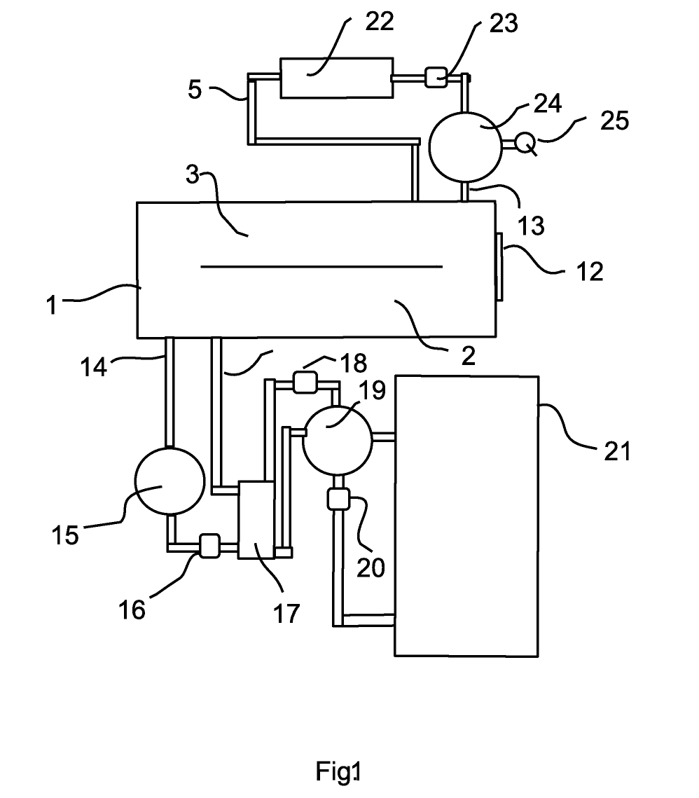

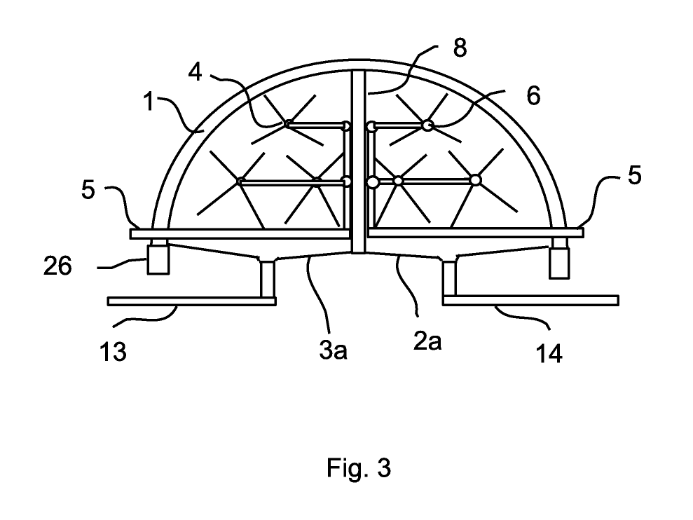

The system described and illustrated in FIGS. 1-4 is operated at low temperatures and atmospheric pressure. It is safe to operate and can be automated. It is inexpensive to build and utilizes low grade waste heat that is normally discarded or natural environmentally derived heat as a heat source. The electrical needs are minimal.

The term “desalination” and any variation as used throughout the specification is defined hereinafter to include: the removal of salts, minerals, or any impurities from a target substance by at least one method of evaporation and condensation.

The term “low temperature” and any variation thereof as used throughout the specification is defined hereinafter to include: temperatures in the 120° Fahrenheit (F) to 160° F. range at sea level and as further described below.

The term “communication” and any variation thereof as used throughout the specification is defined hereinafter to include: an act or instance of transmitting a substance, gas, element, or molecule; a system or structure for transmitting a substance, gas, element, or molecule; a system or structure for moving a substance, gas, element, or molecule; and a technology for the transmission of a substance, gas, element, or molecule.

The term “substance” and any variation thereof as used throughout the specification is defined hereinafter to include: a fluid, a gas, a gaseous mixture, and any combination thereof.

The term “inflatable” and any variation thereof as used throughout the specification is defined hereinafter to include: a plastic or rubber structure capable of receiving air or any gas.

The term “plastic” and any variation thereof as used throughout the specification is defined hereinafter to include: at least one of any of numerous organic, synthetic, or processed materials having a property including any one of elastic, thermoplastic or thermosetting.

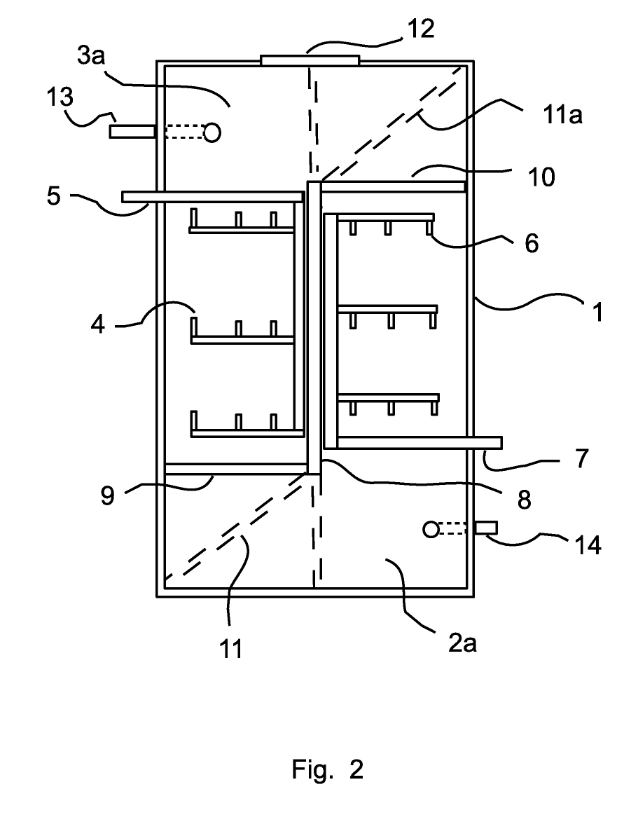

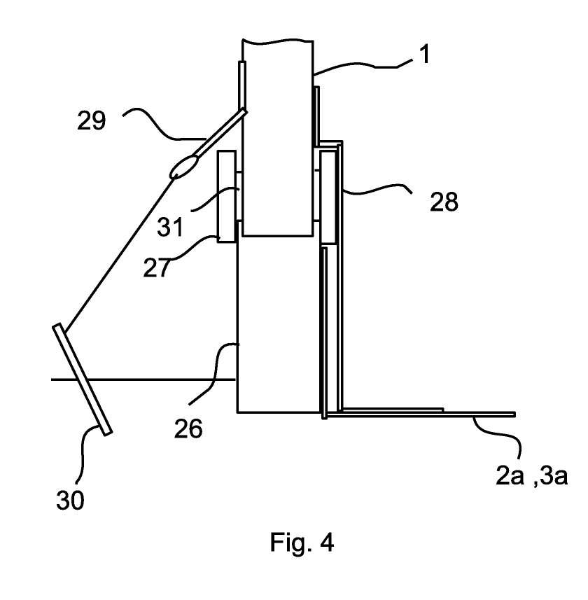

The desalination system illustrated in FIGS. 1-4 includes an inflatable structure (1) having an evaporator section (2) and a condenser section (3). The floor pan shown in FIG. 2 for the evaporator pan (2a) and condenser pan (3a) is mounted higher than the salt water reservoir (15) and a distilled water (DW) reservoir (24) thus allowing gravity flow to be used. Each section (2, 3) is separated by a partial central wall (8). The evaporator pan (2a) and condenser pan (3a) are also separated from each other by dams (9, 10). The pans (2a, 3a) and the central wall 8 and dams (9, 10) are covered with a waterproof plastic liner. This floor liner is joined to the sides of the inflatable structure (1) with a waterproof seal (FIG. 4). The spent salt water collecting in the evaporator section (2) flows by gravity into the salt water reservoir (15). Water from the salt water reservoir (15) is circulated by pump (16) through a heat exchanger (17) where it is heated by water pumped by a pump (18) from a hot water tank (19). The now heated salt water flows from the heat exchanger (17) through piping (7) to spray heads (6) mounted in the evaporator section (2). Some of the hot salt water spray evaporates, saturating the moving carrier air stream. The spray heads (6) are mounted in such a way that the spray pushes the carrier stream in a clockwise direction from a top view of the inflatable structure (1).

The saturated carrier air may include some entrained salt water droplets. A porous knockout panel (11) secured at one end of the evaporator section (2) will remove these entrained salt water droplets. The saturated hot carrier gas then moves into the condenser section (3). The un-evaporated salt water in the evaporator section (2) collects in the evaporator pan (2a) and returns via pipe (14) by gravity feed into the salt water tank reservoir (15). In the condenser section (3) the hot carrier air is cooled when it makes direct contact with sprayed distilled water coolant. The distilled water feed for this cold water spray is pumped by a pump (23) from the distilled water reservoir (24) through a corrugated stainless steel tube heat exchanger (22) that is immersed in cold water. The resulting cool distilled water flows from the heat exchanger (22) through a pipe (5) to the condenser spray heads (4). The resulting distilled water spray comes in direct contact with the hot moist carrier air; cooling the air and condensing moisture form it. The resulting condensate and the spent distilled water coolant collect in the condenser pan (3a) and flow by gravity through a pipe (13) into the distilled water reservoir (24). This distilled water is then either recycled or removed as product through a valve (25). In some cases the distilled water spray produces atomized droplets that are carried by the carrier air. A knock out panel (11a) can be mounted at the end of the evaporator section (2) to enhance condensate recovery if this is a problem. The now cool dry carrier air is recycled through the evaporator section (2).

An access port (12) is installed in the inflatable structure (1) in order to service the inflatable structure (1). A hot water generator (21) provides heat to the hot water tank (19). A pump (20) circulates water from the hot water tank (19), through the hot water generator (21) and back to the hot water tank (19).

In the described exemplary system, heating and cooling of the carrier air during recycle provides the momentum for vapor formation and vapor condensation. Heated salt water sprayed into the evaporator section (2) contacts the carrier air flow, heating it and thus increasing the amount of moisture that it can carry. Some of the heated salt water evaporates producing a saturated hot carrier air. The spray heads (6) are aligned so that the sprayed hot salt water pushes the heated, saturated carrier air in a clockwise direction into the condenser section (3). Chilled distilled water is sprayed into this section. The condenser spray heads (4) are aligned to provide maximum coverage and maximum push to the clockwise movement of the carrier air. The saturated hot moist carrier air contacts the chilled distilled water spray cooling it on contact. This cooling causes condensation of moisture from the carrier air. Condensed product and spent distilled water coolant collect in the condenser pan (3a) and return by gravity into the DW reservoir (24) for recycle. Carrier air at different temperatures has different moisture carrying capabilities. The higher the temperature, the higher the saturation point and the more moisture the carrier air can carry. However, saturation can occur at any temperature. The amount of condensate produced also depends on the temperature differential between the carrier leaving the evaporator section (2) and the carrier air leaving the condenser section (3). The higher the average temperature of like differentials, the higher the distillation rate. This embodiment takes advantage of these characteristics and can theoretically distill water at any temperature as long as the heat input and the differential temperature ranges are adequate.

The construction materials used in the system determine the possible operation temperatures that can be used. In the 120° F. to 160° F. ranges, the structure as well as plumbing can be made of plastic materials (i.e. pvc, cpvc or epdm or other plastics). The salt water side heat exchanger (17) in this embodiment is a titanium plate heat exchanger. However, in certain applications the heat exchanger could be made of temperature tolerant plastic or rubber. The heat for this heat exchanger can come from a solar thermal field at the hot water generator (21), or can be waste heat derived from a geothermal operation, an industrial facility, a power plant or from combustion engine heat and exhaust. Heat in the (120° F. to 160° F.) range can be generated environmentally or can be recovered waste heat that is normally discarded. The cold water side heat exchanger (22) is either a stainless steel plate type heat exchanger or a stainless steel corrugated tube heat exchanger. The cold water used in the heat exchanger (22) can be derived from a stream, pond, ocean or evaporator chiller. The temperature of the cold source will work best if it is below 75° F. The system as is described herein is operated at normal atmospheric pressures.

Hereinafter, the exemplary desalination water system described in the present embodiment will be explained with the use of illustrations in FIGS. 1-4. In the present embodiment, the potable water product can be derived from sea water, brackish water or non-drinkable water sources such as streams, ponds or certain industrial waste streams and certain contaminated aquifers. An additional use for the present embodiment would be the cleanup and recycle of industrial waste waters. These could include but are not limited to paper waste water, fracking waste streams, treated sewage and certain other industrial chemical waste streams.

A configuration of the desalination system is shown in FIG. 1. In all of the discussions below the carrier gas that is cycled through the evaporator (2) and condenser (3) sections will be air. In certain industrial applications the carrier gas could be nitrogen, carbon dioxide or various other gases. The heated salt water in the evaporator (2) and the cool distilled water in the condenser (3) are sprayed in such a way to force the carrier gas to move in a clockwise direction within the structure (1). The salt water in the salt water reservoir (15) is pumped by the pump (16) into the heat exchanger (17) where it is heated by water pumped by the pump (18) from the hot water tank (19). The hot sea water exiting the heat exchanger (17) flows through the pipe (7) into the spray heads (6) in the evaporator section (2). The heated salt water comes in contact with the circulating carrier air heating it. This increases the moisture carrying capacity of the carrier air. The evaporator section (2) is sized so that the maximum heating and maximum saturation of the carrier air is achieved. The spent salt water collects in the evaporator pan (2a) and flows by gravity through pipe (14) back into the salt water reservoir (15) where it is recycled. The heated, moist saturated air in the evaporator section (2) then circulates through a porous knockout panel (11) into the condenser section (3). The knockout panel (11) serves to remove any salt water droplets that are entrained in the carrier air before it enters the condenser section (3). Once in the condenser section (3), the hot moist carrier air comes in direct contact with the cool distilled water spray. The carrier air is cooled causing the moisture carried by it to condense. The condensate and the spent distilled water collect in the condenser pan (3a). The distilled water then flows by gravity through pipe (13) into the distilled water reservoir (24). Some of this distillate product is drawn from the distilled water reservoir (24) through the valve (25). The distilled water in the distilled water reservoir (24) is pumped by the pump (23) through the corrugated stainless steel tubing heat exchanger (22) submerged in a cool water source. The cold distilled water leaving the heat exchanger (22) through the pipe (5) flows into the condenser section (3) into condenser spray heads (4) and the cycle is repeated. The evaporator pan (2a) and condenser pan (3a) are separated by a partial wall (8) and dams (9) and (10). The now cool and dry carrier is passed through a knockout panel (11a) to remove any condensate mist. It then flows into the evaporator (2) and the cycle is repeated.

One alternative embodiment of the distillation system (not illustrated) utilizes an inflatable structure for the evaporator section (2) and condenser section (3) of the system. Details for anchoring this system to the footing are illustrated in FIG. 4. In this alternative embodiment, it is necessary to make a seal between the inflatable structure (1) and the footing (26). One possible method to accomplish this is to build a water proof, U-shaped dam (27) on the top of the footing (26). The structure is then set into the U-shaped dam (27), tied down by exterior structure ties and the U-shaped dam (27) is filled with water. A PVC liner flap (28) is sealed to the structure wall and flaps over the dam and into the pans (2a, 3a). The flap (28) deflects water running down the sides of the structure (1) into the pans (2a, 3a).

The product generated by the present embodiment may need further treatment if it is to be used as potable water. In most cases, this will involve the use of activated charcoal treatment to remove any dissolved plastic leach materials. The product may also be treated with ozone prior to use. If the source of water used for desalination contains contaminants, further treatment of the product may be necessary. In this case, chlorine generated on sight by electrolysis of salt water will be used as a disinfectant prior to filtration through the charcoal filter. The filter will reduce toxic chlorine to non-toxic chloride ion. If for any reason the whole system needs to be disinfected, chlorine treatment followed by water wash and carbon treatment of the wash water can be done.

The desalination system will be sized according to the amount of heat that is available. The capacity of the desalination system could be as low as 2 gal to as much as 2,000 gal of potable water per hour. The structure (1) housing the evaporator section (2) and condenser section (3) can be made to order. The size of the structure (1) required, depends on the carrier air cycle rate and the residence time needed to heat and saturate the circulating carrier air in the evaporator section (2) and the time needed to cool the saturated hot carrier air and condense the moisture from that air stream in the condenser section (3). The normal temperatures for operation of the distillation system will be below 160° F. Because of the low operation temperatures, inflatable plastic structures and plastic plumbing construction materials and tanks can be used. The connecting piping (pvc and cpvc) and pumps for the heated salt water cycle can be sized by estimating the quantity of heat needed to heat the carrier air and evaporate adequate water to provide for a given distillation rate. Once this is known and the temperature differential of the evaporator salt water inlet and outlet feed is estimated, then the expected flow rates can be calculated. In the same way the distilled water coolant flow rates can be estimated. In low temperature applications, the salt water reservoir (15) and the distilled water reservoir (24) are polypropylene tanks sized to provide at least six hours of operation time. Salt water can be taken directly from the source or if pretreatment is necessary, the treated water can be stored in lined earthen ponds prior to use. Distilled water product is stored in polyethylene tanks. In large systems, lined earthen ponds can be used. The interior of the inflatable structure (1) can be accessed through a sealable access port (12) at the end of the structure (1). The spray heads (6) used in the evaporator section (2) are the non-clogging type and can handle most solids that may precipitate from brine concentrates.

A preferred embodiment of the description is provided above. However, it is to be understood that various changes can be made with respect to the present embodiment and all such changes as within the true spirit and scope of the provided description are intended to be included in the accompanying claims. For instance, the described desalination system can be built on a salt water estuary or pond. The salt water and distilled water tanks can be insulated bladder tanks suspended below a floating inflated structure that contains a sealed evaporator and condenser section. In this application, the pumps would be submersible pumps mounted in each of the bladder tanks.

### INDUSTRIAL APPLICABILITY

The desalination system, according to the present description, has the effect of being able to distill water or other volatile solutions at temperatures significantly below the boiling points of those solutions. This means that the heat needed to run the system can be recovered from industrial waste heat streams, from environmental heat sources or other low grade heat sources. Because of the low temperatures involved, inexpensive, non-corroding plastics can be used in the construction of these systems in most applications. Besides providing potable water from salt water or other non-potable water sources, the technology can be used to provide recyclable water for farm or industrial use and or reduce the volume of industrial waste streams such as but not limited to fracking waste, grey water or paper production waste. The use of non-clogging spray nozzles in the evaporator section (2) and easy access to the inflatable structures interior (1), facilitate a wide application for the described system. Modification of the system above can be used for the purification of distillable chemicals such as alcohols, hydrocarbons and other volatile industrial products.

### Process Description

A carrier gas (system air) under the right conditions will become saturated with liquid (water) vapor. The higher the temperature of the carrier gas, the more liquid vapor it can carry. The faster the carrier gas moves, provided that the system can still saturate and heat the gas, the more the potential distillate that can be derived from it. In the system described in the embodiment of FIGS. 1-4, the size of the evaporator and the condenser and the flow rate of the carrier air have to be optimized in order to maximize the distillate rate that can be derived from a limited heat source. Another factor is the temperature differential between the evaporator and the condenser. The larger the differential, the higher the rate of distillation. The cold water source is in the 75° F. range or lower to cool the distilled water coolant if maximum distillation is desired. The heat source should be able to heat the sea water feed to (120° F. to 160° F. range) in order to achieve distillation. The higher the temperature of the salt water feed the better the distillation rate. The flow rates of the salt water feed and the cool distilled water feed can be adjusted to set appropriate temperature ranges.

The process described by the embodiment of FIGS. 1-4 is further provided below. The heated salt water is sprayed into the evaporator section where it heats the surrounding air increasing its moisture carrying capacity. Some of the heated salt water evaporates saturating the surrounding air with moisture. The direction and placement of the spray heads cause the surrounding air to move in a clockwise direction. It is now termed carrier air and moves into the condenser section. The now spent non-evaporated salt water collects in the bottom of the evaporator and flows by gravity back into the salt water tank where it is recycled. The moist hot carrier air entering the condenser section comes in direct contact with distilled water coolant that is sprayed into the condenser section. As the carrier air is cooled by the distilled water coolant, water vapor carried by the air condenses. Both the condensate and the spent distilled water coolant collect in the bottom of the condenser and flow by gravity into the distilled water tank where they are either recycled or are withdrawn from the tank as distillate product.

Perhaps the most attractive application for the above described system is the large scale production of potable water from sea water and brackish water sources. The process is economical, safe and utilizes waste heat or environmentally derived heat sources. Second is the clean-up and recovery of useable products from industrial waste waters such as those found on fracking sites, paper process sites, farm sites and sewage plants.

In other applications where distillation system is a closed system; carrier gases other than air can be used. Low temperature distillation in a non-oxygen environment at atmospheric pressure in the described embodiment above can be applied to any process that involves the purification of products that have a reasonable vapor pressure at the operational temperatures. In some cases, the inflatable structure and liner materials will have to be changed in order to make the system compatible with the application. Distillation of products using this system allows purification to be achieved at temperatures well below the products boiling point. The lack of oxygen and the low temperature used makes the system especially attractive for the purification of oxygen and temperature sensitive materials and combustible products. Again, the heat needed for these operations can be low quality recovered heat that is normally wasted. Potential applications include but are not limited to the purification of volatile bio-fuels such as methanol, ethanol, other alcohols and certain hydrocarbon products and some industrial chemicals such as alcohols, ketones, aldehydes and certain functional hydrocarbons.

The evaporation and condensing system of FIGS. 1-4 includes a structure having an evaporator section and a condenser section. A first nozzle system is disposed in the evaporator section. The first nozzle system is in communication with a first feed pipe disposed at least partially in the structure, the first feed pipe is adapted to be in communication with a first substance. A second nozzle system is disposed in the condenser section; the second nozzle system is in communication with a second feed pipe disposed at least partially in the structure, the second feed pipe is adapted to be in communication with a second substance. A first porous knockout panel is disposed proximate the evaporator section. A second porous knockout panel is disposed proximate the condenser section. A first substance drain is disposed in the evaporator section. A second substance drain is disposed in the condenser section. The first feed pipe is in communication with an evaporator feed tank. The evaporator feed tank includes a first heat exchanger for heating the first substance. The evaporator feed tank is adapted to be in communication with the first substance drain. The first heat exchanger is adapted to receive heat from at least one of: a conventional gas heater, a solar panel heater, recovered waste heat from an industrial process, a combustion engine exhaust recovery system, a low temperature geothermal waste water, and a heater powered by wind or solar. The second feed pipe is in communication with a chilled substance tank, the chilled substance tank includes a second heat exchanger for cooling the second substance. The chilled substance tank is adapted to be in communication with the second substance drain. The second heat exchanger is adapted to receive cooling from at least one of: a conventional evaporative chiller system, a pond, a stream, a lake, a river, and an ocean.

A method of evaporation and condensing using a structure having an evaporator section and a condenser section of FIGS. 1-4 includes placing first nozzle system in the evaporator section. The first nozzle system is in communication with a first feed pipe disposed at least partially in the structure. The first feed pipe is adapted to be in communication with a first substance. Another step includes placing a second nozzle system in the condenser section. The second nozzle system is in communication with a second feed pipe disposed at least partially in the structure. The second feed pipe is adapted to be in communication with a second substance. Another step includes adding a first porous knockout panel proximate the evaporator section. Another step includes adding a second porous knockout panel proximate the condenser section. Another step includes placing a first substance drain in the evaporator section. Another step includes placing a second substance drain in the condenser section. The first feed pipe is placed in communication with an evaporator feed tank. The evaporator feed tank includes a first heat exchanger for heating the first substance. The evaporator feed tank is adapted to be in communication with the first substance drain. The first heat exchanger is adapted to receive heat from at least one of: a conventional gas heater, a solar panel heater, recovered waste heat from an industrial process, a combustion engine exhaust recovery system, a low temperature geothermal waste water, and a heater powered by wind or solar. The second feed pipe is placed in communication with a chilled substance tank, the chilled substance tank includes a second heat exchanger for cooling the second substance. The chilled substance tank is adapted to be in communication with the second substance drain. The second heat exchanger is adapted to receive cooling from at least one of: a conventional evaporative chiller system, a pond, a stream, a lake, a river, and an ocean. The first nozzle system in the evaporator section and the second nozzle system in the condenser section circulate a carrier gas in one of a clockwise or counterclockwise direction throughout the structure. The second nozzle system comes into contact with the carrier gas moving from the evaporator section into the condenser section.

The preceding description has been presented only to illustrate and describe exemplary embodiments of the methods and systems of the claims. It is not intended to be exhaustive or to limit the claims to any precise form disclosed. It will be understood by those skilled in the art that various changes may be made and equivalents may be substituted for elements thereof without departing from the scope of the description. In addition, many modifications may be made to adapt a particular situation or material to the teachings of the description without departing from the essential scope. Therefore, it is intended that the description not be limited to the particular embodiment disclosed as the best mode contemplated for carrying out this description, but that the description will include all embodiments falling within the scope of the claims. The description may be practiced otherwise than is specifically explained and illustrated without departing from its spirit or scope. The scope of the description is limited solely by the following claims.

What is claimed is:

1. An evaporation and condensing system comprising:
a structure having an evaporator section and a condenser section;
a first nozzle system is disposed in the evaporator section; the first nozzle system is in communication with a first feed pipe disposed at least partially in the structure, the first feed pipe is adapted to be in communication with a first substance;
a second nozzle system is disposed in the condenser section; the second nozzle system is in communication with a second feed pipe disposed at least partially in the structure, the second feed pipe is adapted to be in communication with a second substance;
a first porous knockout panel is disposed proximate the evaporator section;
a second porous knockout panel is disposed proximate the condenser section;
a first substance drain is disposed in the evaporator section; and
a second substance drain is disposed in the condenser section.

2. The evaporation and condensing system of claim 1, wherein the first feed pipe is in communication with an evaporator feed tank; the evaporator feed tank includes a first heat exchanger for heating the first substance.

3. The evaporation and condensing system of claim 2, wherein the evaporator feed tank is adapted to be in communication with the first substance drain.

4. The evaporation and condensing system of claim 2, wherein the first heat exchanger is adapted to receive heat from at least one of: a conventional gas heater, a solar panel heater, recovered waste heat from an industrial process, a combustion engine exhaust recovery system, a low temperature geothermal waste water, and a heater powered by wind or solar.

5. The evaporation and condensing system of claim 1, wherein the second feed pipe is in communication with a chilled substance tank, the chilled substance tank includes a second heat exchanger for cooling the second substance.

6. The evaporation and condensing system of claim 5, wherein the chilled substance tank is adapted to be in communication with the second substance drain.

7. The evaporation and condensing system of claim 5, wherein the second heat exchanger is adapted to receive cooling from at least one of: a conventional evaporative chiller system, a pond, a stream, a lake, a river, and an ocean.

8. An evaporation and condensing system comprising:
a structure having an evaporator section and a condenser section;
a first nozzle system is disposed in the evaporator section; the first nozzle system is in communication with a first feed pipe disposed at least partially in the structure, the first feed pipe is adapted to be in communication with a first substance;
a second nozzle system is disposed in the condenser section; the second nozzle system is in communication with a second feed pipe disposed at least partially in the structure, the second feed pipe is adapted to be in communication with a second substance;
a first porous knockout panel is disposed proximate the evaporator section;
a second porous knockout panel is disposed proximate the condenser section;
a first substance drain is disposed in the evaporator section;
a second substance drain is disposed in the condenser section;
wherein the first feed pipe is in communication with an evaporator feed tank; the evaporator feed tank includes a first heat exchanger for heating the first substance;
wherein the evaporator feed tank is adapted to be in communication with the first substance drain;
wherein the first heat exchanger is adapted to receive heat from at least one of: a conventional gas heater, a solar panel heater, recovered waste heat from an industrial process, a combustion engine exhaust recovery system, a low temperature geothermal waste water, and a heater powered by wind or solar;
wherein the second feed pipe is in communication with a chilled substance tank, the chilled substance tank includes a second heat exchanger for cooling the second substance;
wherein the chilled substance tank is adapted to be in communication with the second substance drain; and
wherein the second heat exchanger is adapted to receive cooling from at least one of: a conventional evaporative chiller system, a pond, a stream, a lake, a river, and an ocean.

9. A method of evaporation and condensing using a structure having an evaporator section and a condenser section comprising the steps of:
placing first nozzle system in the evaporator section; the first nozzle system is in communication with a first feed pipe disposed at least partially in the structure, the first feed pipe is adapted to be in communication with a first substance;
placing a second nozzle system in the condenser section; the second nozzle system is in communication with a second feed pipe disposed at least partially in the structure, the second feed pipe is adapted to be in communication with a second substance;
adding a first porous knockout panel proximate the evaporator section;
adding a second porous knockout panel proximate the condenser section;
placing a first substance drain in the evaporator section; and
placing a second substance drain in the condenser section.

10. The evaporation and condensing method of claim 9, wherein the first feed pipe is placed in communication with an evaporator feed tank; the evaporator feed tank includes a first heat exchanger for heating the first substance.

11. The evaporation and condensing method of claim 10, wherein the evaporator feed tank is adapted to be in communication with the first substance drain.

12. The evaporation and condensing method of claim 10, wherein the first heat exchanger is adapted to receive heat from at least one of: a conventional gas heater, a solar panel heater, recovered waste heat from an industrial process, a combustion engine exhaust recovery system, a low temperature geothermal waste water, and a heater powered by wind or solar.

13. The evaporation and condensing method of claim 9, wherein the second feed pipe is placed in communication with a chilled substance tank, the chilled substance tank includes a second heat exchanger for cooling the second substance.

14. The evaporation and condensing method of claim 13, wherein the chilled substance tank is adapted to be in communication with the second substance drain.

15. The evaporation and condensing method of claim 13, wherein the second heat exchanger is adapted to receive cooling from at least one of: a conventional evaporative chiller system, a pond, a stream, a lake, a river, and an ocean.

16. The evaporation and condensing method of claim 9, wherein the first nozzle system in the evaporator section and the second nozzle system in the condenser section circulate a carrier gas in one of a a clockwise or counterclockwise direction throughout the structure.

17. The evaporation and condensing method of claim 16, wherein the second nozzle system comes into contact with the carrier gas moving from the evaporator section into the condenser section.
